(19) United States
(12) Patent Application Publication
(10) Pub. No.: US 2022/0364953 A1
(43) Pub. Date: Nov. 17, 2022

(54) Compilation Method for Reliability Test Load Spectrum of High-Speed Bearing of Electric Drive System

(71) Applicant: UNIVERSITY OF SHANGHAI FOR SCIENCE AND TECHNOLOGY, SHANGHAI (CN)

(72) Inventors: Lihui ZHAO, SHANGHAI (CN); Zhen WANG, SHANGHAI (CN); Qichen LI, SHANGHAI (CN); Longjie LIU, SHANGHAI (CN); Jinzhi FENG, SHANGHAI (CN); Songlin ZHENG, SHANGHAI (CN); Dawei GAO, SHANGHAI (CN); Shuo WENG, SHANGHAI (CN)

(73) Assignee: UNIVERSITY OF SHANGHAI FOR SCIENCE AND TECHNOLOGY, SHANGHAI (CN)

(21) Appl. No.: 17/631,450

(22) PCT Filed: Aug. 3, 2021
(86) PCT No.: PCT/CN2021/110328

§ 371 Date: Jan. 29, 2022

(30) Foreign Application Priority Data
Aug. 7, 2020 (CN) 202010786198.6

(51) Int. Cl. G01M 13/04; G01M 17/007

(52) U.S. Cl. CPC G01M 13/04; G01M 17/007

(57) ABSTRACT

The present invention discloses a compilation method for a reliability test load spectrum of a high-speed bearing of an electric drive system. The method comprises the following steps: based on load data of a whole life cycle of an electric drive system, correlating a leading failure load of a high-speed bearing; counting an action frequency of each load level by a multi-dimensional load joint counting method; constructing a bearing mechanical balance equation; determining a reliability test load level by damage contribution distribution and cumulative damage contribution distribution of different load levels; according to a principle of a consistent overall frequency and consistent damage, determining a time of the reliability test load level; and in combination with extreme load working conditions, finally constructing a reliability test load spectrum of the high-speed bearing. The constructed reliability test load spectrum is correlated to an actual failure mode, which can effectively verify a reliability level of the high-speed bearing, shorten reliability test time and provide support for high-quality development of the high-speed bearing.

### Technical Field

The present invention belongs to the technical field of reliability analysis of electric drive systems, in particular to a compilation method for a reliability test load spectrum of a high-speed bearing of an electric drive system.

### BACKGROUND

As an effective way of sustainable development of automobiles, electrification has been strongly supported by strategic planning and industrial policies in different countries.

The electric drive system is a core component of vehicle electrification.

Higher requirements have been proposed for stability, reliability and durability of high-speed bearings of electric drive systems because of characteristics of a new energy vehicle drive motor, such as a wider speed regulation range, a large starting torque, high power density and high efficiency.

At present, there are rare reliability test methods and technical evaluation specifications for high-speed bearings of electric drive systems. For the reliability assessment of a single part or component, screening and evaluation methods of a highly accelerated life and a highly accelerated stress under simple working conditions and continuous loading are often adopted, but it is difficult to effectively cover the variable amplitude load history of high-speed bearings under multiple working conditions during actual use by users.

Therefore, it is an urgent necessity to propose a method to construct a reliability test load spectrum correlated to actual failure modes of a high-speed bearing based on a load time history of an electric drive system in a whole life cycle, so as to effectively verify a reliability level of the high-speed bearing and provide technical support for positive high-performance development of the bearing.

### SUMMARY OF THE INVENTION

The purpose of the present invention is to provide a compilation method for a reliability test load spectrum of a high-speed bearing of an electric drive system, which correlates with actual failure modes of the high-speed bearing, covers damage targets of the bearings in a whole life cycle, and constructs the reliability test load spectrum of the high-speed bearing under variable amplitude loading and multiple working conditions. The present invention can effectively verify a reliability level of the high-speed bearing and provide technical support for high-quality development of the high-speed bearing in the electric drive system.

To achieve the above purpose, the present invention provides the following solution: The present invention provides a compilation method for a reliability test load spectrum of a high-speed bearing of an electric drive system, which comprises the following steps:

step 1: according to a load spectrum of a whole life cycle of an electric drive system, correlating a leading failure load of a high-speed bearing, and analyzing joint distribution characteristics of multi-dimensional loads of a rotation speed and a torque;

step 2: constructing a high-speed bearing balance equation under the joint loads;

step 3: calculating a high-speed bearing life and bearing damage and conducting damage analysis;

step 4: determining a reliability test load level and a time proportion relation of each typical load level;

step 5: determining a damage target of the whole life cycle of the bearing; and

step 6: compiling a reliability test load spectrum of the high-speed bearing.

Preferably, a multi-dimensional load joint counting method is used to count action frequencies under different rotation speeds and different torque levels in the load spectrum of the electric drive system in the whole life cycle, and the number of turns of the high-speed bearing under the different load levels is obtained.

Preferably, a Newton-Raphson iterative method is used to calculate different contact loads of the high-speed bearings, comprising the following sub-steps:

step 2-1: constructing the balance equation of the high-speed bearing under a radial load; and

step 2-2: constructing the balance equation of the high-speed bearing under the radial load and an axial load.

Preferably, a specific method of constructing the balance equation of the high-speed bearing under the radial load comprises the following steps:

Under high-speed bearing centrifugal force, Qᵢ, is a contact load between a steel ball and a bearing inner ring, Qₑ is the contact load between the steel ball and a bearing outer ring, so that centrifugal force Fₑ of a bearing ball is:

Qₑⱼ−Qᵢⱼ=Fe (1)

Where j is the number of the bearing ball;

Fₑ=½mDₘωₘ² (2)

In equation (2), m is the mass of the steel ball; Dₘ is an average diameter of the high-speed bearing; ωₘ is a revolution angular velocity of the bearing ball;
A radial displacement of the bearing under the radial load at any angular position ψⱼ, is:

$${δ}_{φ} = {δ}_{r} cos {ψ}_{j} - \frac{1}{2} {P}_{d} = {δ}_{max} [ 1 - \frac{1}{2 ε} ( 1 - cos {ψ}_{j} ) ] , \qquad ( 3 )$$

In equation (3), δr is a relative radial displacement between inner and outer rolling paths of the high-speed bearing; P_{d} is a radial internal clearance of the high-speed bearing; δₘₐₓ is a total elastic deformation at the contact position between a rolling body and the inner and outer rings of a radial load action line; and ε is a load distribution parameter of the high-speed bearing, where ε is calculated as follows:

$$ε = \frac{1}{2} ( 1 - \frac{{P}_{d}}{2 {δ}_{r}} ) , \qquad ( 4 )$$

A contact load Qᵢⱼ of the inner ring of the high-speed bearing is:

$${Q}_{ij} = {Q}_{max} [ 1 - \frac{1}{2 ε} ( 1 - cos {ψ}_{j} ) ] , \qquad ( 5 )$$

$${Q}_{max} = {{K}_{n} ( {δ}_{r} - \frac{1}{2} {P}_{d} )}^{1.5} , \qquad ( 6 )$$

Where Qₘₐₓ is a maximum contact load between a roller of the high-speed bearing and the rolling path; and Kₙ is a contact stiffness coefficient between the roller and the rolling path of the high-speed bearing;
A radial contact load Qr; of the high-speed bearing is:

Qᵣⱼ=Q_{iψ}cos ψⱼ (7)

In equation (7), Q_{iψ}, is a contact load at different position angles ψⱼ;

According to the mechanical balance equation of the bearing, the radial contact load of the high-speed bearing is obtained. The mechanical balance equation of the high-speed bearing is:

$${F}_{r} = {\sum }_{ψ = 0}^{\pm {ψ}_{i}} {Q}_{i ψ} cos {ψ}_{j} , \qquad ( 8 )$$

In equation (8), Kₙ is a contact stiffness coefficient between the roller and the rolling path of the high-speed bearing.

Preferably, when the high-speed bearing bears both the radial load and the axial load simultaneously, the inner and outer rings of the high-speed bearing will generate relative displacements, including the axial displacement 8a and the radial displacement δᵣ. The outer ring of the high-speed bearing is fixed. After the high-speed bearing is loaded, the inner ring of the high-speed bearing will generate a relative displacement relative to the outer ring of the high-speed bearing;

Db is the diameter of the high-speed bearing ball; D, is the average bearing diameter of the high-speed bearing; and aₒ is an initial contact angle between the high-speed bearing ball and the rolling path;

After the high-speed bearing is loaded, a circumferential radius R, where a curvature center of an inner ring rolling path groove is located is:

Rᵢ=0.5Dₘ+(rᵢ−0.5D_{b})cos α₀ (9)

A circumferential radius Ro where the curvature center of a rolling path groove of the high-speed bearing outer ring is located is:

Rₒ=0.5Dₘ−(rₑ−0.5D_{b})cos α₀ (10),

At any angular position Vi, a distance r between the curvature centers of inner and outer rolling path grooves of the high-speed bearing is:

r=[(GD_{b} sinαₒ+δₐ)²+(GD_{b} cosαₒ,+δᵣ,cosψ)²]^{1/2} (11),

In equation (11), r is a curvature radius of the rolling path groove of the inner and outer rings of the high-speed bearing; G=fₑ+fᵢ−1, fₙ is a curvature radius coefficient of the rolling path groove of a high-speed bearing cover; fₙ=rₙ/D_{b}, wherein n=i and e, which respectively represent the inner ring and outer ring of the high-speed bearing; 6a and 6r represent the relative axial displacement and the relative radial displacement of the inner and outer rings of the high-speed bearing respectively;

Dimensionless quantities are introduced:

$${\overline{δ}}_{a} = \frac{{δ}_{a}}{{GD}_{b}} , \qquad ( 12 )$$

$${\overline{δ}}_{r} = \frac{{δ}_{r}}{{GD}_{b}} , \qquad ( 13 )$$

The following equations are set:

N=sinαₒ+δ̅ₐ̅ (14),

L=cosαₒ+δ̅ᵣ̅ cosψ (15),

In equations (14) and (15), N and L are dimensionless quantities. Equations (14) and (15) are substituted into Equation (11), so that:

r=GD_{b}(N²+L²)^{1/2} (16),

A total deformation δ₁₀₄ obtained by the contact between the bearing ball and the inner and outer rings of the high-speed bearing at the angular position ψ is:

δ_{ψ}=GD_{b}[(N²+L²)^{1/2} −1] (17),

According to equation (1), the contact load Q_{ψ}, of the inner ring of the high-speed bearing is:

$${Q}_{ψ} = {{( \frac{G {D}_{b}}{{K}_{p}} )}^{3 / 2} [ {( {N}^{2} + {L}^{2} )}^{1 / 2} - 1 ]}^{3 / 2} , \qquad ( 18 )$$

In equation (18), Kₚ is an elastic deformation constant of high-speed bearing point contact.

The contact angle α_{ψ} between the bearing ball and the high-speed bearing ring at any angular position is

$$sin {α}_{ψ} = \frac{N}{{( {N}^{2} + {L}^{2} )}^{1 / 2}} , \qquad ( 19 )$$

According to balance conditions, the radial load and the axial load acting on the high-speed bearing are Fᵣ and Fₐ respectively, so that:

$${F}_{r} = {\sum }_{ψ = 0}^{\pm π} {Q}_{ψ} cos {ψcosα}_{ψ} , \qquad ( 20 )$$

$${F}_{a} = {\sum }_{ψ = 0}^{\pm π} {Q}_{ψ} sin {α}_{ψ} , \qquad ( 21 )$$

Equations (20) and (21) are nonlinear equation systems of unknown numbers δ̅ₐ̅ and δ̅ᵣ̅. A Newton-Raphson iterative method is used in MATLAB for programming. Small initial values δ̅ₐ̅ and δ̅ᵣ̅ are set, and parameters of the high-speed bearing are input to obtain the actual deformations δ a and δr of the inner and outer rings of the high-speed bearing. Equations (14) to (18) are combined to obtain the contact load of the high-speed bearing.

Preferably, in step 3, that method for calculating the life of the high-speed bearing is as follow:

Based on standards improved by a Lundberg-Palmgren bearing life theory, the life of the high-speed bearing under different load levels is calculated.

A calculation method of high-speed bearing damage is as follows: a Palmgren-Miner linear cumulative damage rule is adopted, and a life of the rolling path of the high-speed bearing is L₁ under the working condition of an equivalent dynamic load P₁, and if the bearing runs for Nᵢ turns under the working condition, equivalent damage of the high-speed bearing under the working condition P₁ is: D₁=N₁/L₁; If the high-speed bearing experiences a random road load and runs for N₁,N₂, . . . ,Nₙ turns under equivalent loads of P₁, P₂, . . . ,Pₙ, the damage caused by the random road load to the high-speed bearing is as follows:

$$D = {\sum }_{i = 1}^{n} {D}_{i} = {\sum }_{i = 1}^{n} \frac{{N}_{i}}{{L}_{i}} , \qquad ( 22 )$$

In equation (22), n is a set of working conditions of the high-speed bearing, and for each corresponding working condition i, the fatigue life of the high-speed bearing is Lᵢ turns, and under the working condition, the high-speed bearing runs for Nᵢ turns, wherein Nᵢ<Lᵢ.

Preferably, in step 4, the reliability test load level is determined according to the following characteristics:

Characteristic 4.1: different distribution characteristics of damage contribution of the high-speed bearing are involved;

Characteristic 4.2: selection of the reliability test load level should include the typical working conditions of the load spectrum of the electric drive system in the whole life cycle, and at the same time, the damage contribution should be high; and

Characteristic 4.3: the reliability test load spectrum includes extreme load working conditions.

Preferably, the extreme load working conditions include the extreme speed and the maximum torque of the high-speed bearing motor of the electric drive system.

Preferably, in step 4, steps of determining the time proportion relation of different typical load levels are as follows:

step 4.1: transferring a load frequency near a target load working condition to a given target load based on a principle of a consistent overall action frequency, so as to obtain a time proportion under all typical load levels; and

step 4.2: dynamically adjusting the time of each load working condition from the perspective of damage to meet a total damage target of the high-speed bearing in the whole life cycle load spectrum of the electric drive system.

Preferably, in step 6, compilation contents of the reliability test load spectrum comprise:

Content 6.1: The reliability test load spectrum of the high-speed bearing should cover a variable amplitude loading history of the high-speed bearing under the multiple working conditions during actual operation;

Content 6.2: In the process of compiling the reliability test load spectrum, extreme load working conditions should be considered according to a motor limit speed and a maximum torque; and

Content 6.3: During determination of time of acceleration or deceleration in the process of transfer between load working conditions of different grades, slopes of a load rising stage and a falling stage are extracted based on an original load history, and the time when the reliability test load level rises or falls is determined based on a slope distribution model.

The present invention has the technical effects: the reliability test load spectrum constructed by the present invention is correlated to an actual failure mode of the high-speed bearing, which can effectively verify a reliability level of the high-speed bearing and provide support for high-quality development of the high-speed bearing of the electric drive system.

### BRIEF DESCRIPTION OF THE DRAWINGS

In order to more clearly explain the embodiments of the present invention or the technical solutions in the prior art, the drawings needed in the embodiments will be briefly introduced below. It is apparent that the drawings in the following description are only some embodiments of the present invention, and for those of ordinary skill in the art, other drawings can be obtained according to these drawings without making creative labor.

FIG. 1 is a flow chart of a compilation method for a reliability test load spectrum of a high-speed bearing;

FIG. 2 is a schematic diagram of partial load data in a whole life cycle of 300,000 km of an electric drive system;

FIG. 3 is a distribution histogram of joint distribution counting of torques and rotation speeds;

FIG. 4 is a schematic diagram of a bearing radial displacement;

FIG. 5 is a schematic diagram of an inner ring displacement under a bearing joint load;

FIG. 6 is a distribution diagram of damage contribution of a 6208 bearing under each load level;

FIG. 7 is a distribution diagram of cumulative damage contribution of a 6208 bearing under different torque levels;

FIG. 8 is a distribution diagram of cumulative damage contribution of a 6208 bearing under different rotation speed grades;

FIG. 9 is a distribution diagram of damage contribution of a 6308 bearing under each load level;

FIG. 10 is a distribution diagram of cumulative damage contribution of a 6308 bearing under different torque levels;

FIG. 11 is a distribution diagram of cumulative damage contribution of a 6308 bearing under different rotation speed grades;

FIG. 12 is a ladder diagram of damage contribution of a 6208 bearing under a torque of −107 Nm;

FIG. 13 is a ladder diagram of damage contribution of a 6208 bearing under a torque of −86 Nm;

FIG. 14 is a ladder diagram of damage contribution of a 6308 bearing under a rotation speed of 3515 rpm;

FIG. 15 is a ladder diagram of damage contribution of a 6308 bearing under a rotation speed of 7627 rpm;

FIG. 16 is a schematic diagram of a cyclic working condition of a high-speed bearing reliability test; and FIG. 17 is a comparison chart of total damage of a 300,000 km original load spectrum and a reliability test load spectrum.

### DETAILED DESCRIPTION OF THE PREFERRED EMBODIMENTS

Next, the technical solutions in the embodiments of the present invention will be clearly and completely described with reference to the drawings in the embodiments of the present invention. It is apparent that the described embodiments are only part of the embodiments of the present invention, not all of them. Based on the embodiments in the present invention, all other embodiments obtained by those of ordinary skill in the art without creative work are within the protection scope of the present invention.

In order to make the above-mentioned purposes, features and advantages of the present invention more obvious and easier to understand, the present invention will be described in further detail below with reference to the drawings and specific implementations.

### Embodiment 1: The flow chart of the overall implementation scheme of the

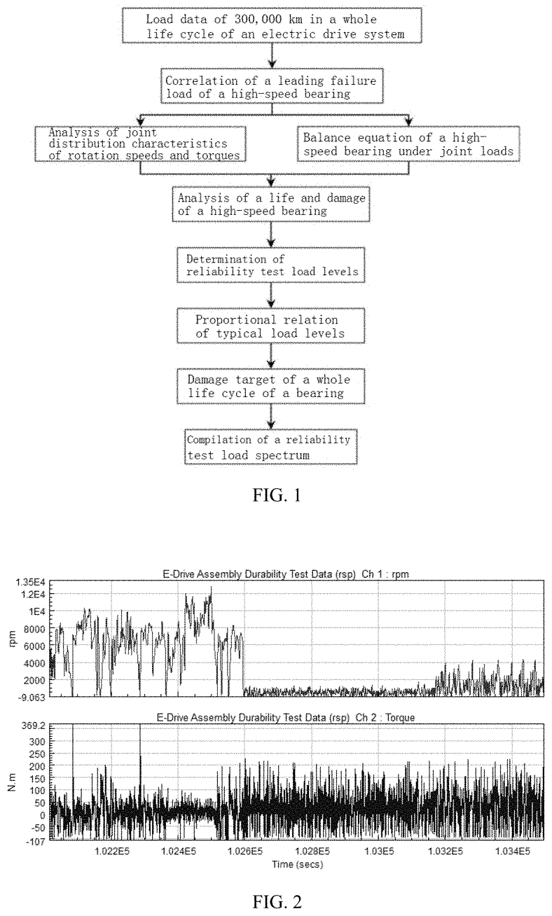

present invention is shown in FIG. 1, which comprises correlation of load data of 300,000 km in a whole life cycle of an electric drive system with a leading failure load of a high-speed bearing, analysis of load joint distribution characteristics, construction of a balance equation of the high-speed bearing under joint loads, analysis of life and damage of the high-speed bearing, determination of a reliability test load level and a proportion relation between typical load levels, a damage target of the bearing in a whole life cycle and compilation of a reliability test load spectrum. The specific implementation steps are as follows:

Step 1: based on the load data of 300,000 km in the whole life cycle of the electric drive system, joint distribution of rotation speeds and torque loads is counted, and the number of rotating turns of the bearing under different rotation speed and torque levels in the original load spectrum is obtained:

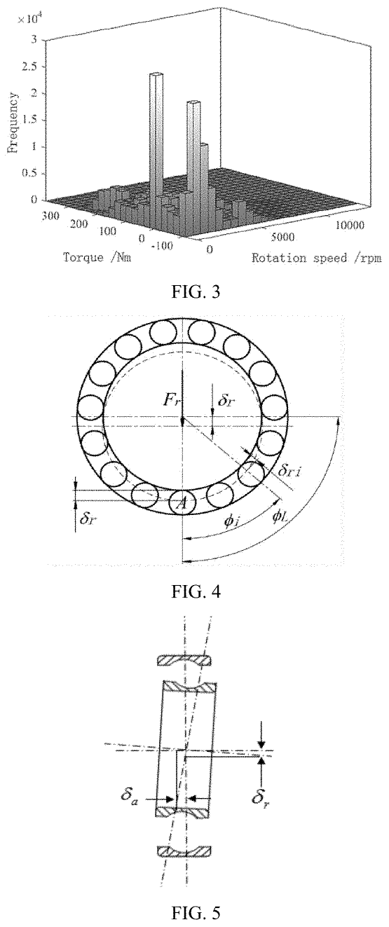

The joint distribution of the rotation speeds and the torque load is counted; the load data of 300,000 km is divided into different load levels; action frequencies under different load levels are counted; and the numbers of bearing rotation turns under the different load levels are calculated according to the frequency distribution characteristics of each load level, wherein part of the load data is shown in FIG. 2. The present invention divides the rotation speeds and torques into 24 grades respectively, and results after load counting of a reliability test cycle working condition in the load data of 300,000 km are shown in FIG. 3. Through the joint distribution histogram of the rotation speeds and torques, it can be concluded that in the original load spectrum: the frequency is high under the low rotation speeds and negative torques; and the frequency of load counting under the high rotation speeds and high torques is low.

Step 2: a high-speed bearing balance equation is constructed:

By construction of a balance equation of the high-speed bearing under joint loads, a contact load of the bearing under different rotation speed and torque levels is determined.

Force bearing conditions and models of high-speed bearings at both ends of an electric drive system motor are different, and their contact loads are different. The bearings at both ends of an input shaft are taken as the research object. When the load is driving forward, the bearing far away from the motor side bears an axial load and a radial load, while the bearing near the motor side bears the radial load. When the load is driving in the opposite direction, the bearing far away from the motor side bears the radial load, while the bearing near the motor side bears the radial load and the axial load.

The construction of the balance equation of the high-speed bearing under the joint loads in step 2 comprises the following sub-steps:

Step 2-1: in a balance equation of the high-speed bearing under a radial load, considering bearing centrifugal force, if Qᵢ and Qₑ are contact loads between a steel ball and inner and outer rings of the bearing respectively, then:

Qₑⱼ−Qᵢⱼ=Fe (1)

In equation (1), Qᵢ is the contact load between the steel ball and the bearing inner ring; Qₑ is the contact load between the steel ball and the bearing outer ring; j is the number of the bearing steel ball; and Fₑ is the centrifugal force of the steel ball:

Fₑ=½mDₘωₘ² (2)

In equation (2), m is the mass of the steel ball; Dₘ is the average diameter of the bearing; and ωₘ is revolution angular velocity of the steel ball.

FIG. 4 is a schematic diagram of bearing radial displacement.

As shown in FIG. 4, the radial displacement of the bearing under the radial load at any angular position ψⱼ; is:

$${δ}_{φ} = {δ}_{r} cos {ψ}_{j} - \frac{1}{2} {P}_{d} = {δ}_{max} [ 1 - \frac{1}{2 ε} ( 1 - cos {ψ}_{j} ) ] , \qquad ( 3 )$$

In equation (3), δᵣ is a relative radial displacement between inner and outer rolling paths of the bearing; P_{d} is a radial internal clearance of the bearing; δₘₐₓ is a total elastic deformation at the contact position between a rolling body and the inner and outer rings of a radial load action line; and s is a load distribution parameter of the bearing, where s is calculated as follows:

$$ε = \frac{1}{2} ( 1 - \frac{{P}_{d}}{2 {δ}_{r}} ) , \qquad ( 4 )$$

In equation (4) δᵣ is a relative radial displacement between the inner and outer rolling paths; and P_{d} is a radial internal clearance of the bearing.

A contact load Qᵢⱼ of the inner ring of the bearing is:

$${Q}_{ij} = {Q}_{max} [ 1 - \frac{1}{2 ε} ( 1 - cos {ψ}_{j} ) ] , \qquad ( 5 )$$

$${Q}_{max} = {{K}_{n} ( {δ}_{r} - \frac{1}{2} {P}_{d} )}^{1.5} , \qquad ( 6 )$$

In equation (6), Qₘₐₓ is a maximum contact load between a ball and the rolling path; and Kₙ is a contact stiffness coefficient between the roller and the rolling path.

A radial contact load is:

Qᵣⱼ=Q_{iψ}cos ψⱼ (7)

In equation (7), Qv, is a contact load at different position angles ψⱼ;

According to the mechanical balance equation of the bearing, the radial contact load is obtained. The mechanical balance equation of the bearing is:

$${F}_{r} = {\sum }_{ψ = 0}^{\pm {ψ}_{i}} {Q}_{i ψ} cos {ψ}_{j} , \qquad ( 8 )$$

In equation (8), Fᵣ is the radial force borne by the bearing.

In step 2-2, according to the balance equation of high-speed bearing under the radial load and the axial load, when the bearing bears both the radial load and the axial load, the inner and outer rings will produce relative displacements, including an axial displacement δₐ and a radial displacement δᵣ. As shown in FIG. 5, assuming that the outer ring is fixed, the inner ring will produce a relative displacement relative to the outer ring after the bearing is loaded.

After the bearing is loaded, a circumferential radius Rᵢ where a curvature center of an inner ring rolling path groove is located is:

Rᵢ=0.5Dₘ+(rᵢ−0.5D_{b})cos α₀ (9)

In equation (9), D_{b} is the diameter of the bearing ball; Dₘ is the average diameter of the bearing; and aₒ is an initial contact angle between the ball and the rolling path.

The circumferential radius Rₒ where a curvature center of an outer rolling path groove is located is:

Rₒ=0.5Dₘ−(rₑ−0.5D_{b})cos α₀ (10),

At any angular position ψ, the distance r between the curvature centers of inner and outer ring grooves is:

r=[(GD_{b} sinαₒ+δₐ)²+(GD_{b} cosαₒ,+δᵣ,cosψ)²]^{1/2} (11),

In equations (10) and (11), rₙ is the curvature radius of the rolling path groove; G=fₑ+fᵢ^{31 1}, fₙ is a curvature radius coefficient of the rolling path groove; fₙ=rₙ/D_{b}, wherein n=i and e, which respectively represent the inner ring and outer ring of the bearing; and δₐ and δᵣ represent the relative axial displacement and relative radial displacement of the inner and outer rings of the bearing respectively;

Dimensionless quantities are introduced:

$${\overline{δ}}_{a} = \frac{{δ}_{a}}{{GD}_{b}} , \qquad ( 12 )$$

$${\overline{δ}}_{r} = \frac{{δ}_{r}}{{GD}_{b}} , \qquad ( 13 )$$

The following equations are set:

N=sinαₒ+δ̅ₐ̅ (14),

L=cosαₒ+δ̅ᵣ̅ cosψ (15),

In equations (14) and (15), N and L are dimensionless quantities. Equations (14) and (15) are substituted into Equation (11), so that:

r=GD_{b}(N²+L²)^{1/2} (16 ),

The total deformation δ_{ψ}, obtained by the contact between the steel ball and the inner and outer rings at the position ψ is:

δ_{ψ}=GD_{b}[(N²+L²)^{1/2} −1] (17),

According to equation (1), the contact load Q_{ψ} of the bearing inner ring is:

$${Q}_{ψ} = {{( \frac{G {D}_{b}}{{K}_{p}} )}^{3 / 2} [ {( {N}^{2} + {L}^{2} )}^{1 / 2} - 1 ]}^{3 / 2} , \qquad ( 18 )$$

In equation (18), Kₚ is an elastic deformation constant of bearing point contact;

At this time, the contact angle α_{ψ} between the steel ball and the ring at any angular position can be obtained as follows:

$$sin {α}_{ψ} = \frac{N}{{( {N}^{2} + {L}^{2} )}^{1 / 2}} , \qquad ( 19 )$$

According to balance conditions, if the radial load and the axial load acting on the bearing are Fᵣ and Fₐ respectively, then:

$${F}_{r} = {\sum }_{ψ = 0}^{\pm π} {Q}_{ψ} cos ψ cos {α}_{ψ} , \qquad ( 20 )$$

$${F}_{a} = {\sum }_{ψ0}^{\pm π} {Q}_{ψ} sin {α}_{ψ} , \qquad ( 21 )$$

Equations (20) and (21) are nonlinear equation systems of unknown numbers δ̅ₐ̅ and δ̅r̅. A Newton-Raphson iterative method is used in MATLAB for programming. Small initial values δ̅ₐ̅ and δ̅r̅ are set, and parameters of the high-speed bearing are input to obtain the actual deformations δ̅ₐ̅ and δ̅ᵣ̅ of the inner and outer rings of the bearing. Equations (14) to (18) are combined to obtain the contact load of the bearing.

Step 3, a life and damage of the high-speed bearing are analyzed. As for a calculation method of the bearing life, the present invention adopts an ISO standard improved based on a Lundberg-Palmgren bearing life theory, which needs to calculate an equivalent dynamic load and a rated static load of the bearing. According to the rated life theory of bearings, the rated life L₁₀ of the ball bearing is:

L₁₀=(Lᵢ^{-ε}+Lₑ^{-ε})^{-1/ε} (22),

In equation (22), ε is ta life index; Lᵢ is the rated life of the inner rolling path; and Lₑ is the rated life of the outer rolling path;

The rated life of the inner rolling path is:

$${L}_{i} = {( \frac{{Q}_{c μ j}}{{Q}_{μ j}} )}^{3} , \qquad ( 23 )$$

The rated life of the outer rolling path is:

$${L}_{e} = {( \frac{{Q}_{cvj}}{{Q}_{vj}} )}^{3} , \qquad ( 24 )$$

In equations (23) and (24), Q_{cuj} and Q^{cvj} are the rated dynamic loads of the rings; and Q_{μj} Qᵥⱼ refer to the equivalent dynamic loads of the rings;

A rated dynamic load calculation equation is:

$${Q}_{c} = 98.1 {( \frac{f}{2 f - 1} )}^{0.41} \frac{{( 1 ∓ γ )}^{1.39}}{{( 1 \pm γ )}^{1 / 3}} {( \frac{γ}{cos α} )}^{0.3} {D}_{b}^{1.8} {Z}^{- 1 / 3} , \qquad ( 25 )$$

In equation (25), m represents the rated dynamic loads of the inner and outer rings of the bearing respectively; f is a curvature radius coefficient of the rolling path groove; γ is a bearing structural parameter; γ=D_{b} cos α/Dₘ, where α is a contact angle; and Z is the number of rollers;

The equivalent dynamic load Q_{μi} of the inner rolling path is:

$${Q}_{μ i} = {( \frac{1}{Z} {\sum }_{j = 1}^{j = Z} {Q}_{j}^{3} )}^{\frac{1}{3}} , \qquad ( 26 )$$

The equivalent dynamic load Qᵥⱼ of the non-rotating outer rolling path is:

$${Q}_{vj} = {( \frac{1}{Z} {\sum }_{j = 1}^{j = Z} {Q}_{j}^{\frac{10}{3}} )}^{0.3} , \qquad ( 27 )$$

In equations (26) and (27), j is the number of the bearing ball and Z is the total number of the balls;

As for a calculation method of bearing damage, the present invention adopts a Palmgren-Miner linear cumulative damage rule, and the life of the rolling path is L₁ under a working condition of an equivalent dynamic load P₁. If the bearing runs for N₁ turns under the working condition, the equivalent damage of the bearing under the working condition P₁ is: D₁=N₁/L₁. If the bearing experiences a random road load and, under the equivalent loads P₁,P₂, . . . , Pₙ, runs for N₁,N₂, . . . ,Nₙ turns in sequence, the damage D caused by the random road load to the bearing is:

$$D = {\sum }_{i = 1}^{n} {D}_{i} = {\sum }_{i = 1}^{n} \frac{{N}_{i}}{{L}_{i}} , \qquad ( 28 )$$

In equation (28), n is a set of working conditions of the bearing, and for each corresponding working condition i, the corresponding fatigue life of the bearing is Lᵢ turns. However, under the working condition, the bearing only runs for Nᵢ turns, wherein Nᵢ<Lᵢ

In the present embodiment, the model of the bearing near the motor side is 6208/C3, and the cumulative distribution result of the damage contribution of the 6208 bearing is obtained by calculating the damage contribution of the bearing under different rotation speeds and torque levels. As shown in FIG. 6, the damage contribution of the 6208 bearing is the highest under the negative torques and less under the positive torques. In order to clarify the difference of damage contribution under the different load levels, the load levels with higher cumulative damage contribution are screened out as the basis for load selection.

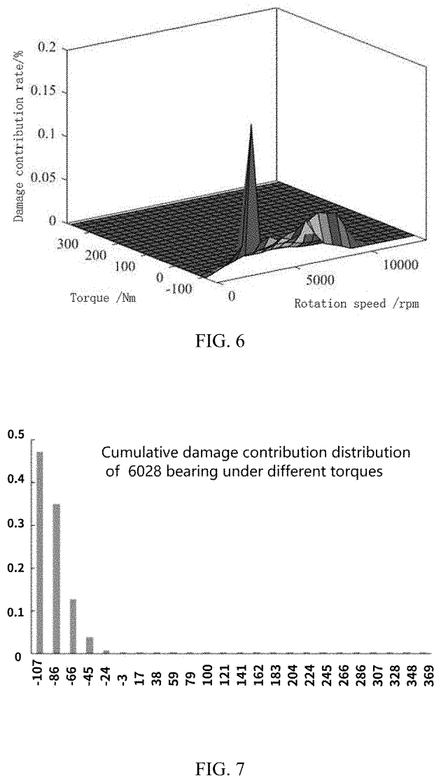

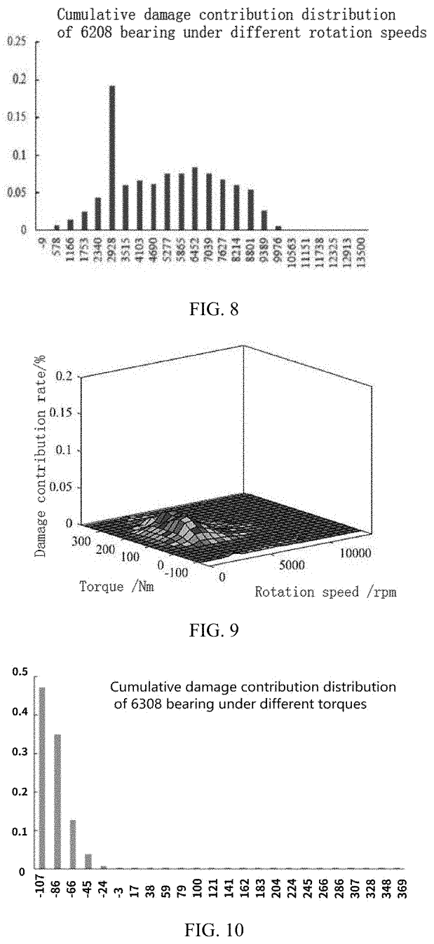

Statistics are conducted on the cumulative damage intensity of the 6208 bearing under the different rotation speeds and torque levels respectively. As shown in FIG. 7 and FIG. 8, the damage contribution is higher when the negative torque is −107 Nm and −86 Nm, and the damage contribution is the highest when the rotation speed is around 3000 rpm. Secondly, the cumulative damage contribution to the bearing is relatively higher in ranges with middle and high rotation speeds.

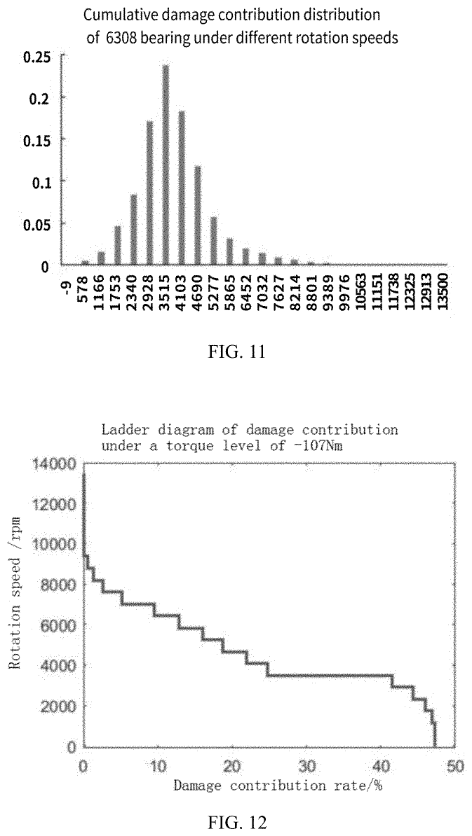

In the present embodiment, the model of the bearing away from the motor side is 6308/C3, and the cumulative distribution result of the damage contribution of the 6308 bearing is obtained by calculating the damage contribution of the bearing under different rotation speeds and torque levels. As shown in FIG. 9, the damage contribution of the 6308 bearing caused by the positive torque conditions is higher, and the cumulative damage intensity of the 6308 bearing under the different rotation speeds and torque levels is counted separately, as shown in FIG. 10 and FIG. 11. When the rotation speed is between 1000 rpm and 5000 rpm and the torque is between 50 Nm and 300 Nm, the damage contribution to the 6308 bearing is the highest.

Step 4: a reliability test load level and a time proportion relation of each typical load level are determined: The reliability test load level is determined according to the principle of covering different distribution characteristics of bearing damage contribution.

The selection of the reliability test load level should include typical working conditions in the 300,000 km load data, and meanwhile, damage contribution should be high. The reliability test load spectrum also includes extreme load working conditions.

During the determination of the time proportion relation of each typical load level, for a working condition with a given target rotation speed and a given torque, firstly, a load frequency near a target load working condition is transferred to a given target load based on the principle of a consistent overall action frequency, so as to obtain a time proportion of all typical load levels, and then, the time of each load working condition is dynamically adjusted according to the principle of consistent damage so as to meet a total bearing damage target in the load data of 300,000 km.

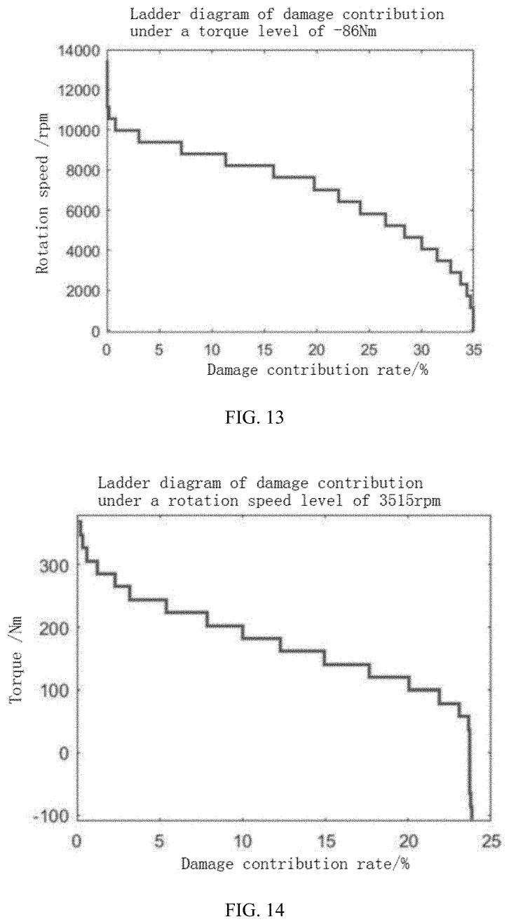

According to the cumulative distribution characteristics of 6208 bearing damage contribution, the damage contribution is higher when the torque is −107 Nm and −86 Nm. Therefore, the damage contribution under different rotation speeds when the torque is −107 Nm and −86 Nm respectively is counted separately, and ladder diagrams of the damage contribution are drawn, as shown in FIG. 12 and FIG. 13, wherein when the torque is −107 Nm and the rotation speed is in a range of middle and low rotation speeds, such as about 2928 rpm, the damage contribution is high; and when the torque is −86 Nm, the damage contribution is higher when the rotation speed is in a range of middle and high rotation speeds, such as around 8000 rpm.

According to the cumulative distribution characteristics of 6308 bearing damage contribution, the bearing damage contribution is higher when the torque is positive and the rotation speed is between 1000 rpm and 5000 rpm. Based on the characteristics of 6308 bearing damage distribution, according to the damage contribution distribution under different torques and the same rotation speed, the torque load level with higher damage contribution can be selected under the given rotation speed.

As shown in FIG. 14, with 3515 rpm, a range of middle and low rotation speeds, as an example, the ladder diagram of damage contribution under different torque levels at the rotation speed of 3515 rpm is drawn. Under the rotation speed of 3515 rpm, the damage contribution is higher when the torque is between 100 Nm and 200 Nm.

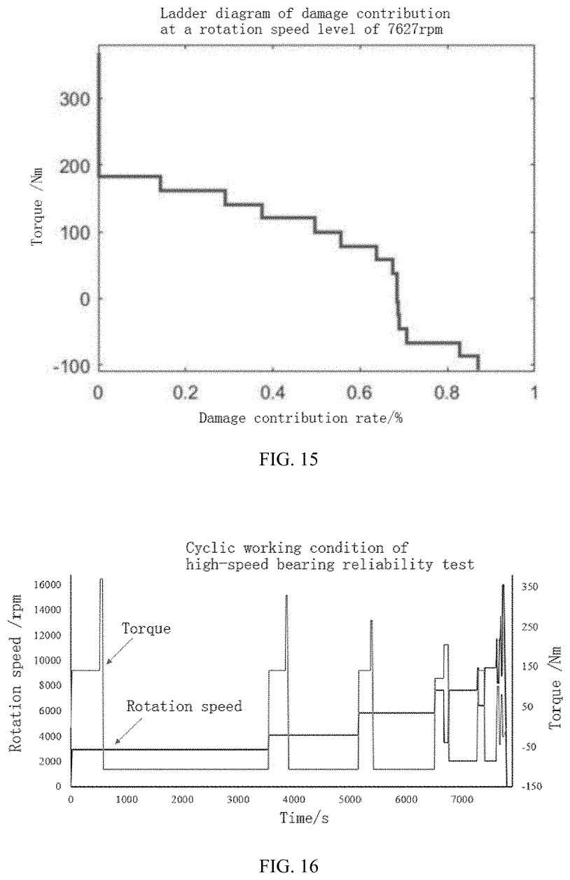

As shown in FIG. 15, with 7627 rpm, a range of middle and high rotation speeds, as an example, a ladder diagram of damage contribution under different torque levels at the rotation speed of 7627 rpm is drawn. When the rotation speed is 7627 rpm, the selected torque grade is −86 Nm/120 Nm/162 Nm.

Step 5: a damage target of the bearing in the whole life cycle is determined:

In the process of compiling the bearing reliability test load spectrum, in order to determine the total running time of the reliability test load spectrum, it is necessary to make clear the damage target of the bearing in the 300,000 km load data, so as to determine the number of cycles of test working conditions.

As shown in Table 1, damage values and total damage targets of the bearing under a single cycle of 300,000 km load data in the whole life cycle are counted.

TABLE 1

| | Damage caused by | 2956 h total |
|---|---|---|
| Bearing model | a single cycle | damage target |
| 6208/C3 | 0.141015168 | 3.384364021 |
| 6308/C3 | 0.022495362 | 0.539888697 |

Step 6: a reliability test load spectrum is compiled:

The reliability test load spectrum of the bearing should cover a variable amplitude loading history of the bearing under various working conditions in an actual operation process. When the lower rotation speed rises, the torque rises at the same time, and the working conditions of middle rotation speeds and high torques are assessed; when the higher speed rises, the torque drops, and the working conditions of high rotation speeds and low torques are assessed; and meanwhile, when the torque rises, the rotation speed drops and service conditions such as the working conditions of low rotation speeds and high torques are assessed. In addition, the 300,000 km load data includes the highest torque of 369 Nm and the motor limit speed of 16000 rpm. These extreme working conditions should be considered in the process of compiling the reliability test load spectrum.

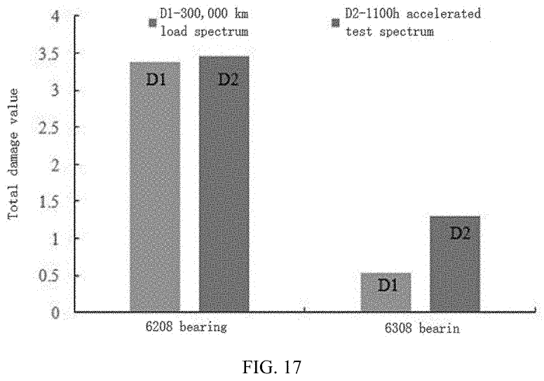

As for the time of acceleration or deceleration stage in the transfer process between the typical working conditions, slopes of a load rising stage and a falling stage are extracted from an original load history. Based on a slope distribution model, the time of rising or falling among various reliability test load levels can be effectively selected. As shown in Table 2, there are 21 load working conditions grades and bearing endurance working conditions grades after matching the time of each grade. Among them, 10 s and 20 s are taken as transition loading time between each load change. 1100h is taken as the total target time of the reliability test load spectrum, and finally a single cycle duration of 7800 s and 507 cycles are compiled. The time history of the working condition of a single reliability test cycle is shown in FIG. 16.

TABLE 2

| Time/s | Rotation speed/rpm | Torque/Nm |
|---|---|---|
| 500 | 2928 | 140 |
| 40 | 2928 | 369 |
| 2950 | 2928 | −107 |
| 300 | 4100 | 140 |
| 20 | 4100 | 328 |
| 1250 | 4100 | −107 |
| 200 | 5865 | 140 |
| 20 | 5865 | 266 |
| 1100 | 5865 | −107 |
| 150 | 7627 | 120 |
| 70 | 3515 | 204 |
| 500 | 7627 | −86 |
| 10 | 9389 | 59 |
| 100 | 6452 | 140 |
| 200 | 9389 | −86 |
| 10 | 11738 | 38 |
| 20 | 8214 | 100 |
| 10 | 11738 | −45 |
| 10 | 13500 | 17 |
| 10 | 8800 | 79 |
| 10 | 16000 | −24 |

According to the acting effect of the load spectrum with the whole life cycle of 300,000 km, the 6208 bearing is prone to failure at first. In the process of compiling the reliability test load spectrum, the damage target of the 6208 bearing should be mainly met first. The damage of the finally compiled 1100h reliability test load spectrum is compared with that of the load spectrum with the whole life cycle of 300,000 km. As shown in FIG. 17, for the 6208 bearing, the damage caused by the compiled 1100h reliability test load spectrum is 2% higher than that of the original load spectrum. For the 6308 bearing, the damage caused by the compiled 1100h reliability test load spectrum is 143% higher than that of the original load spectrum. From the perspective of damage, the compiled reliability test load spectrum can reproduce the damage caused by the load spectrum with the whole life cycle of 300,000 km of the electric drive system within 1100h.

The above-mentioned embodiments only describe the preferred modes of the present invention, and do not limit the scope of the present invention.

Without departing from the design spirit of the present invention, all kinds of variations and improvements made by those of ordinary skill in the art to the technical solution of the present invention should fall within the protection scope determined by the claims of the present invention.

1-10. (canceled)

11. A compilation method for a reliability test load spectrum of a high-speed bearing of an electric drive system, characterized by comprising the following steps:
step 1: according to a load spectrum of a whole life cycle of an electric drive system, correlating leading failure loads of a high-speed bearing, and analyzing joint distribution characteristics of multi-dimensional loads of a rotation speed and a torque;
step 2: constructing a high-speed bearing balance equation under the joint loads;
the step 2 of constructing the high-speed bearing balance equation comprises calculating different contact loads of the high-speed bearings by a Newton-Raphson iterative method, comprising the following sub-steps:
step 2-1: constructing the balance equation of the high-speed bearing under a radial load; and
step 2-2: constructing the balance equation of the high-speed bearing under the radial load and an axial load.
step 3: calculating a high-speed bearing life and bearing damage and conducting damage analysis;
step 4: determining a reliability test load level and a time proportion relation of each typical load level;
in step 4, the reliability test load grade is determined according to the following characteristics:
characteristic 4.1: different distribution characteristics of damage contribution of the high-speed bearing are involved;
characteristic 4.2: selection of the reliability test load grade should comprise the typical working conditions of the load spectrum of the electric drive system in the whole life cycle, and at the same time, the damage contribution should be high; and
characteristic 4.3: the reliability test load spectrum comprises extreme load working conditions.
step 5: determining a damage target of the whole life cycle of the bearing; and
step 6: compiling a reliability test load spectrum of the high-speed bearing.

12. The compilation method for the reliability test load spectrum of the high-speed bearing of the electric drive system according to claim 1, characterized in that:
in the step 1, a main method of analyzing joint distribution characteristics of multi-dimensional loads for the high-speed bearing is:
a multi-dimensional load joint counting method is used to count action frequencies under different rotation speeds and different torque levels in the load spectrum of the electric drive system in the whole life cycle, and the number of turns of the high-speed bearing under the different load levels is obtained.

13. The compilation method for the reliability test load spectrum of the high-speed bearing of the electric drive system according to claim 1, characterized in that:
a specific method of constructing the balance equation of the high-speed bearing under the radial load comprises:
under high-speed bearing centrifugal force, Qᵢ is a contact load between a steel ball and a bearing inner ring, Qₑ is the contact load between the steel ball and a bearing outer ring, so that centrifugal force F_{c} of a bearing ball is:
Qₑⱼ−Qᵢⱼ=Fe (1)
where j is the number of the bearing ball;
Fₑ=½mDₘωₘ² (2)
in equation (2), m is the mass of the steel ball; Dₘ is an average diameter of the high-speed bearing; ωₘ is a revolution angular velocity of the bearing ball;
a radial displacement δ₁₀₄ of the bearing under the radial load at any angular position ψⱼ is:
$${δ}_{φ} = {δ}_{r} cos {ψ}_{j} - \frac{1}{2} {P}_{d} = {δ}_{max} [ 1 - \frac{1}{2 ε} ( 1 - cos {ψ}_{j} ) ] , \qquad ( 3 )$$
in Equation (3), δᵣ is a relative radial displacement between inner and outer rolling paths of the high-speed bearing; P_{d} is a radial internal clearance of the high-speed bearing; δₘₐₓ is a total elastic deformation at the contact position between a rolling body and the inner and outer rings of a radial load action line;
and ε is a load distribution parameter of the high-speed bearing, wherein ε is calculated as follows:
$$ε = \frac{1}{2} ( 1 - \frac{{P}_{d}}{2 {δ}_{r}} ) , \qquad ( 4 )$$
a contact load Qᵢⱼ of the inner ring of the high-speed bearing is:
$${Q}_{ij} = {Q}_{max} [ 1 - \frac{1}{2 ε} ( 1 - cos {ψ}_{j} ) ] , \qquad ( 5 )$$
$${Q}_{max} = {{K}_{n} ( {δ}_{r} - \frac{1}{2} {P}_{d} )}^{1.5} , \qquad ( 6 )$$
where: Qₘₐₓ is a maximum contact load between a roller of the high-speed bearing and the rolling path; Kₙ is a contact stiffness coefficient between the roller and the rolling path of the high-speed bearing;
a radial contact load Qrj of the high-speed bearing is:
Qᵣⱼ=Q_{iψ}cos ψⱼ (7)
in equation (7), Q_{iψ} is a contact load at different position angles_{104 j};
according to the mechanical balance equation of the bearing, the radial contact load of the high-speed bearing is obtained; and the mechanical balance equation of the high-speed bearing is:
$${F}_{r} = {\sum }_{ψ = 0}^{\pm {ψ}_{i}} {Q}_{i ψ} cos {ψ}_{j} , \qquad ( 8 )$$
in equation (8), Kₙ is a contact stiffness coefficient between the roller and the rolling path of the high-speed bearing.

14. The compilation method for the reliability test load spectrum of the high-speed bearing of the electric drive system according to claim 3, characterized in that:
when the high-speed bearing bears both the radial load and the axial load at the same time, the inner and outer rings of the high-speed bearing generate relative displacements, comprising the axial displacement δₐ and the radial displacement δᵣ; the outer ring of the high-speed bearing is fixed; and after the high-speed bearing is loaded, the inner ring of the high-speed bearing generates a relative displacement relative to the outer ring of the high-speed bearing;
D_{b} is the diameter of the high-speed bearing ball; Dₘ is the average bearing diameter of the high-speed bearing, and aₒ is an initial contact angle between the high-speed bearing ball and the rolling path;
after the high-speed bearing is loaded, a circumferential radius Rᵢ where a curvature center of an inner ring rolling path groove is located is:
Rᵢ=0.5Dₘ+(rᵢ−0.5D_{b})cos α₀ (9)
a circumferential radius Rₒ where the curvature center of a rolling path groove of the high-speed bearing outer ring is located is:
Rₒ=0.5Dₘ−(rₑ−0.5D_{b})cos α₀ (10),
at any angular position ψ, a distance r between the curvature centers of inner and outer rolling path grooves of the high-speed bearing is:
r=[(GD_{b} sinαₒ+δₐ)²+(GD_{b} cosαₒ,+δᵣ,cosψ)²]^{1/2} (11),
in equation (11), r is a curvature radius of the rolling path groove of the inner and outer rings of the high-speed bearing; G=fₑ+fᵢ⁻¹, fₙ is a curvature radius coefficient of the rolling path groove of a high-speed bearing cover; fₙ=rₙ/D_{b}, wherein n=i and e, which respectively represent the inner ring and outer ring of the high-speed bearing; δₐ and δᵣ represent the relative axial displacement and the relative radial displacement of the inner and outer rings of the high-speed bearing respectively;
dimensionless quantities are introduced:
$$\overline{{δ}_{a}} = \frac{{δ}_{a}}{{GD}_{b}} , \qquad ( 12 )$$
$$\overline{{δ}_{r}} = \frac{{δ}_{r}}{{GD}_{b}} , \qquad ( 13 )$$
the following equations are set:
N=sinαₒ+δ̅ₐ̅ (14),
L=cosαₒ+δ̅ᵣ̅ cosψ (15),
in equations (14) and (15), N and L are dimensionless quantities; and equations (14) and (15) are substituted into equation (11), so that:
r=GD_{b}(N²+L²)^{1/2} (16),
a total deformation δ_{ψ}, obtained by the contact between the bearing ball and the inner and outer rings of the high-speed bearing at the angular position ψ is:
δ_{ψ}=GD_{b}[(N²+L²)^{1/2} −1] (17),
according to equation (1), the contact load Q_{ψ} of the inner ring of the high-speed bearing is:
$${{{Q}_{ψ} ( \frac{{GD}_{b}}{{K}_{p}} )}^{3 / 2} [ {( {N}^{2} + {L}^{2} )}^{1 / 2} - 1 ]}^{3 / 2} , \qquad ( 18 )$$
in equation (18), Kₚ is an elastic deformation constant ofhigh-speed bearing point contact;
the contact angle α_{ψ}between the bearing ball and the high-speed bearing ring at any angular position is
$$sin {α}_{ψ} = \frac{N}{{( {N}^{2} + {L}^{2} )}^{1 / 2}} , \qquad ( 19 )$$
according to balance conditions, the radial load and the axial load acting on the high-speed bearing are Fᵣ and Fₐ respectively, so that:
$${F}_{r} = {\sum }_{ψ = 0}^{\pm π} {Q}_{ψ} cos ψcos {α}_{ψ} , \qquad ( 20 )$$
$${F}_{a} = {\sum }_{ψ = 0}^{\pm π} {Q}_{ψ} sin {α}_{ψ} , \qquad ( 21 )$$
equations (20) and (21) are nonlinear equation systems of unknown numbers δ̅ₐ̅ and δ̅ᵣ̅; a Newton-Raphson iterative method is used in MATLAB for programming; small initial values δ̅ₐ̅ and δ̅ᵣ̅ are set, and parameters of the high-speed bearing are input to obtain the actual deformations δₐ and δᵣ of the inner and outer rings of the high-speed bearing; and equations (14) to (18) are combined to obtain the contact load of the high-speed bearing.

15. The compilation method for the reliability test load spectrum of the high-speed bearing of the electric drive system according to claim 1, characterized in that:
in step 3, that method for calculating the life of the high-speed bearing is as follow: based on standards improved by a Lundberg-Palmgren bearing life theory, the life of the high-speed bearing under different load levels is calculated;
a calculation method of high-speed bearing damage is as follows: a Palmgren-Miner linear cumulative damage rule is adopted, and a life of the rolling path of the high-speed bearing is L₁ under the working condition of an equivalent dynamic load P_{I}, and if the bearing runs for N₁ turns under the working condition, equivalent damage of the high-speed bearing under the working condition P₁ is: D₁=N₁/L₁;
if the high-speed bearing experiences a random road load and runs for N₁,N₂, . . . ,Nₙ turns under equivalent loads of P₁, P₂, . . . Pₙ, the damage caused by the random road load to the high-speed bearing is as follows:
$$D = {\sum }_{i = 1}^{n} {D}_{i} = {\sum }_{i = 1}^{n} \frac{{N}_{i}}{{L}_{i}} , \qquad ( 22 )$$
in equation (22), n is a set of working conditions of the high-speed bearing, and for each corresponding working condition i, the fatigue life of the high-speed bearing is Lᵢ turns, and under the working condition, the high-speed bearing runs for Nᵢ turns, wherein Nᵢ<Lᵢ.

16. The compilation method for the reliability test load spectrum of the high-speed bearing of the electric drive system according to claim 1, characterized in that:
the extreme load working conditions comprise the extreme speed and the maximum torque of the high-speed bearing motor of the electric drive system.

17. The compilation method for the reliability test load spectrum of the high-speed bearing of the electric drive system according to claim 1, characterized in that:
in step 4, steps of determining the time proportion relation of different typical load levels are as follows:
step 4.1: transferring a load frequency near a target load working condition to a given target load based on a principle of a consistent overall action frequency, so as to obtain a time proportion under all typical load levels; and
step 4.2: dynamically adjusting the time of each load working condition from the perspective of damage to meet a total damage target of the high-speed bearing in the whole life cycle load spectrum of the electric drive system.

18. The compilation method for the reliability test load spectrum of the high-speed bearing of the electric drive system according to claim 1, characterized in that:
in step 6, compilation contents of the reliability test load spectrum comprise:
content 6.1: the reliability test load spectrum of the high-speed bearing should cover a variable amplitude loading history of the high-speed bearing under the multiple working conditions during actual operation;
content 6.2: in the process of compiling the reliability test load spectrum, extreme load working conditions should be considered according to a motor limit speed and a maximum torque; and
content 6.3: during determination of time of acceleration or deceleration in the process of transfer between load working conditions of different grades, slopes of a load rising stage and a falling stage are extracted based on an original load history, and the time when the reliability test load level rises or falls is determined based on a slope distribution model.
